(19) United States
(12) Patent Application Publication
(10) Pub. No.: US 2011/0199285 A1
(43) Pub. Date: Aug. 18, 2011

(54) METHOD AND APPARATUS FOR WAVEFORM COMPRESSION AND DISPLAY

(76) Inventors: Alexander Kantorov, Dublin, CA (US); Sundeep Chauhan, Fremont, CA (US)

(21) Appl. No.: 12/896,954

(22) Filed: Oct. 4, 2010

Related U.S. Application Data
(60) Provisional application No. 61/305,817, filed on Feb. 18, 2010.

(51) Int. Cl. G09G 3/20; G06K 9/46

(52) U.S. Cl. 345/55; 382/232

(57) ABSTRACT

A method for displaying waveform data may compress and transfer a large collection of data (e.g., a waveform) acquired from a device onto a screen without compromising any major features of the waveform. Waveform data maybe acquired with a data acquisition instrument. The acquisition instrument may perform in-line calculations to produce two-point sets from the data. The two-point sets may be transferred through an interface bus. The two-point sets may then be displayed as representations of the waveform data as vertical lines of pixels.

This application claims priority under US Provisional Application 61305817 filed 18 Feb. 2010.

### BACKGROUND OF THE INVENTION

The present invention generally relates to displaying waveform data on pixel based display system. More particularly, the invention relates to accurately compressing waveform data and displaying the compressed data on a screen in pixel format.

In the field of test and measurement instrumentation, and specifically, modular instrument apparatus, where the captured/measured data is transferred to a main server/processor via a data bus, typical instrument apparatus may capture data using front-end analog circuitry and store it in a fast memory. Once the capture is complete, the data may be transferred to a main server/computer memory and subsequently processed for display. Transfer may take place through a data bus which can follow many different protocols. Transfer of large quantities of data may generally introduce dead-time and may thus limit the amount of data which can be placed in capture memory for subsequent processing.

When displaying waveform data, large data sets may exceed the resolution of a screen on which the waveform data will be displayed. Typical screen resolution does not exceed 2048 pixels, while waveform data may have hundreds of millions of points.

As can be seen, there is a need for a system to compress and transfer a large collection of data (e.g., a waveform) acquired from a device onto a screen without compromising any major features of the waveform.

### SUMMARY OF THE INVENTION

In one aspect of the present invention, apparatus for analysis of waveform data may comprise: a data acquisition instrument for acquiring waveform data; and a data compression engine for performing calculations in-line with the data acquisition instrument to produce two-point sets from the data.

In another aspect of the present invention, a method for displaying waveform data in pixels of a display may comprise the steps of: sampling a waveform to determine data points for each sampling time; determining a time interval of a pixel on the display; selecting a number of the sampled data points during a time interval associated with a pixel of the display; assigning a first set of the selected number of the sampled data points to a first one of the time intervals; assigning a second set of the selected number of sampled data points to a second one of the time intervals; determining maximum and minimum excursions of the waveform data within the first selected time interval; determining maximum and minimum excursions of the sampled data points within the second selected time interval; determining magnitude of a last sampled data point within the first selected time interval; determining magnitude of a first sampled data point within the second selected time interval; calculating a crossover location on a y-axis as a function of a time interval associated with first pixel column; establishing a display of a first vertical line of pixels wherein the first line includes the magnitude of the minimum and maximum excursion of the first selected time interval and the crossover locations on both sides of the pixel column; and establishing a display of a second vertical line of pixels wherein the second line includes the magnitude of the minimum and maximum excursion of the second selected time interval and the crossover locations on both sides of the pixel column.

In still another aspect of the invention, a system for displaying waveform data may comprise a data acquisition instrument for determining waveform data; a waveform compression engine integral with the instrument; a data transfer bus; a display unit; and wherein the data transfer bus transfers compressed waveform data to the display unit.

These and other features, aspects and advantages of the present invention will become better understood with reference to the following drawings, description and claims.

### BRIEF DESCRIPTION OF THE DRAWINGS

FIG. 1 is an exemplary waveform with various data points identified in accordance with an embodiment of the invention;

FIG. 2 is a pixel-based representation of data points of FIG. 1 in a first set of pixel columns in accordance with an embodiment of the invention;

FIG. 3 is a pixel-based representation of data points of FIG. 1 in a second set of pixel columns in accordance with an embodiment of the invention;

FIG. 4 is a diagram of a relationship between threshold levels and colors of portions of a pixel column in accordance with an embodiment of the invention;

FIG. 5 is a diagram of a relationship between digital data and colors of portions of a pixel column in accordance with an embodiment of the invention;

FIG. 6 is a block diagram of a system for displaying waveform data in accordance with an embodiment of the invention; and

FIG. 7 is a flow chart of a method for acquiring and displaying waveform data in accordance with the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system in which measurement data may be captured through an analog/digital front-end. While the captured data is being stored in a fast memory, an in-line waveform compression algorithm may be running to provide a real-time result. As soon as the capture is complete, the compressed waveform data memory may be ready to be read out through a system/peripheral bus in order to be displayed.

A waveform may be a collection of digitized values (in time or amplitude) taken at a preset interval (sampling rate). In order to draw a waveform on a screen, the waveform data must be converted into x and y coordinates. The x coordinates may be calculated from the sampling rate by accumulating consecutive measurements of time for each data point, while the y coordinates are the measurement data (i.e., amplitude data) from the waveform. If there are more sampled waveform points (C) than a number (P) of pixels on the x axis of a screen, then the waveform must be compressed to fit onto the screen without losing any of its features. This may be achieved by having multiple waveform measurements share a single x coordinate location on the x axis of the screen (i.e., share a single pixel column on the screen). Multiple waveform measurements sharing an x coordinate may not have to have the same y coordinate. Variable y coordinates on a particular x coordinate may be represented as a vertical line of pixels. Since any line can be defined by two points, the vertical line of pixels formed by sharing the x coordinate can be described by minimum (Min) and maximum (Max) values in a collection of waveform data points Wi.

Typically a waveform may be measured from a trigger event. It is possible that the trigger event may fall between two sampling points. To compensate for any trigger event that falls between two sampling points, an interpolated data point between the triggering event measurement and a previous sampled measurement may be generated. Typically the interpolation may be linear, but any interpolation method may be used.

A time T, represented by each pixel on the display device, may then be computed using the equation T=(T_{c}+T₀)/P where T_{c} is a total sampling acquisition time and T₀ is a time offset between the trigger event location and the first point sampled after the trigger event and P is the number of pixels on an x axis of the display. T may be a floating point number since T_{c}+T₀ is not guaranteed to be a multiple of P. The number (G) of points that need to share a pixel can be obtained using the equation Gi=Round (Twi), where i=1 to n; where n is the display width in pixels; and where Twi is the end time of Wi and is calculated as Twi=T*i, where i=1 to n. Amplitude of waveform data at an interpolated time of the trigger event location may be added in the first set (W1) that includes the trigger event to compute a Min/Max. This may also be the first crossover point for W1.

It should be noted that vertical lines alone do not accurately represent the captured waveform. This is because from one Min/Max vertical line to an adjacent Min/Max vertical line, there is no guarantee that the Min/Max Y ranges will overlap or represent a true crossover location. Thus, either a gap or improper connection between the adjacent Min/Max vertical lines could develop. To avoid any potential gaps or improper crossover locations, a connecting line between adjacent vertical lines representing a true crossover location in both amplitude and time axis may be required.

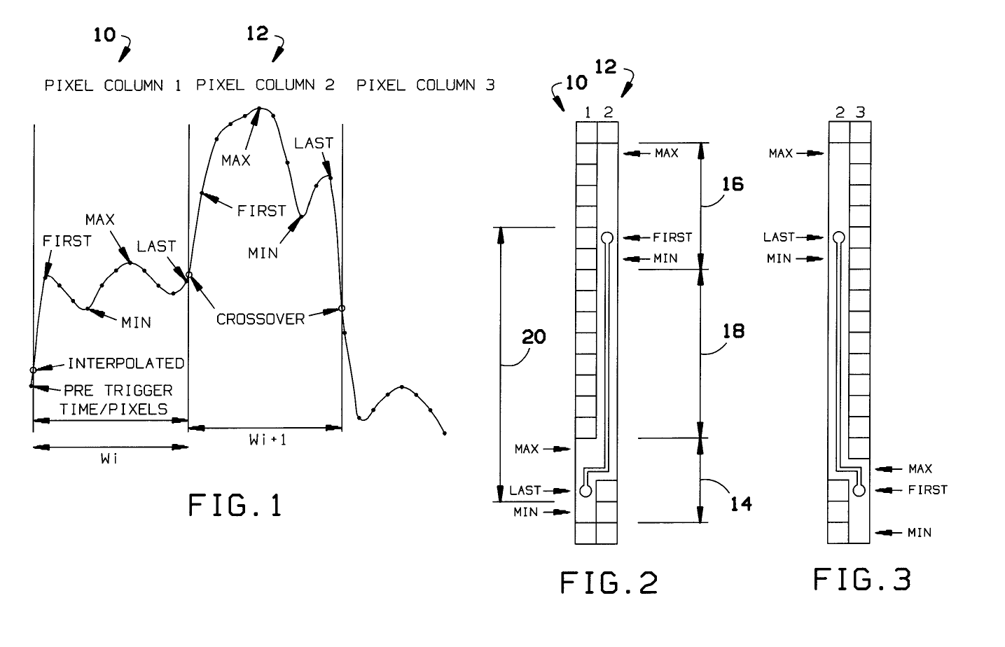

Referring now to FIGS. 1, 2 and 3, it may be seen that Min and Max points of a waveform of FIG. 1 may be represented by vertical locations of pixels as in FIG. 2. Similarly, a value difference between Min and Max may be represented by a vertical line of pixels. Thus vertical line 14 of pixels in column 10 of FIG. 2 may represent a difference between Min and Max of the waveform in Wi of FIG. 1. A magnitude of the line 14 of pixels may be referred to as a Min/Max pair for Wi. A Min/max-pair line of pixels 16 may also be established in column 12 for Min and Max values of the waveform in Wi+1.

It may be seen that, for example, Wi Max may be less than Wi+1 Min. Consequently, there may be a gap 18 between the two vertical lines of pixels 14 and 16 representing these values. In order to accurately represent the data we may need to include both the adjacent crossover points in the Min/Max calculations of each pixel column. To accurately define the crossover locations on the y axis from the last data point of Wi−1 and the first data point of Wi for the pixel boundary from Wi−1 to Wi, a fractional part of Twi may be factored in. This fractional part may be the time period T₀ for the first pixel column.

Because partial points cannot be displayed, rounding must take place to put the points in their closest x-axis location. As the last point in a Wi set approaches a pixel border, the first point in Wi+1 may move away from the same pixel border due to a fixed sample time. The y-axis position defining the crossover point from Wi to Wi+1 may be adjusted to reflect the resultant displaced location of the first and last points. This procedure may be repeated across the entire waveform to create a collection of vertical lines defined by two-point sets that may describe the waveform with no feature loss. Furthermore, no matter how many points are contained in Wi, only two parameters are required to fully describe one G worth of the waveform, the two parameters being minimum and maximum (Min/Max) pair for a vertical line of pixels. Thus waveform data may be compressed into these two-parameter sets. Thus the bandwidth required to display long captures may be reduced.

In cases where total number of captured points in the waveform, (C) is less than or equal to the number of pixels (P) in the display, one may use the same method to compute the crossover points spanning across multiple pixels, thus, providing a more accurate representation of the captured data.

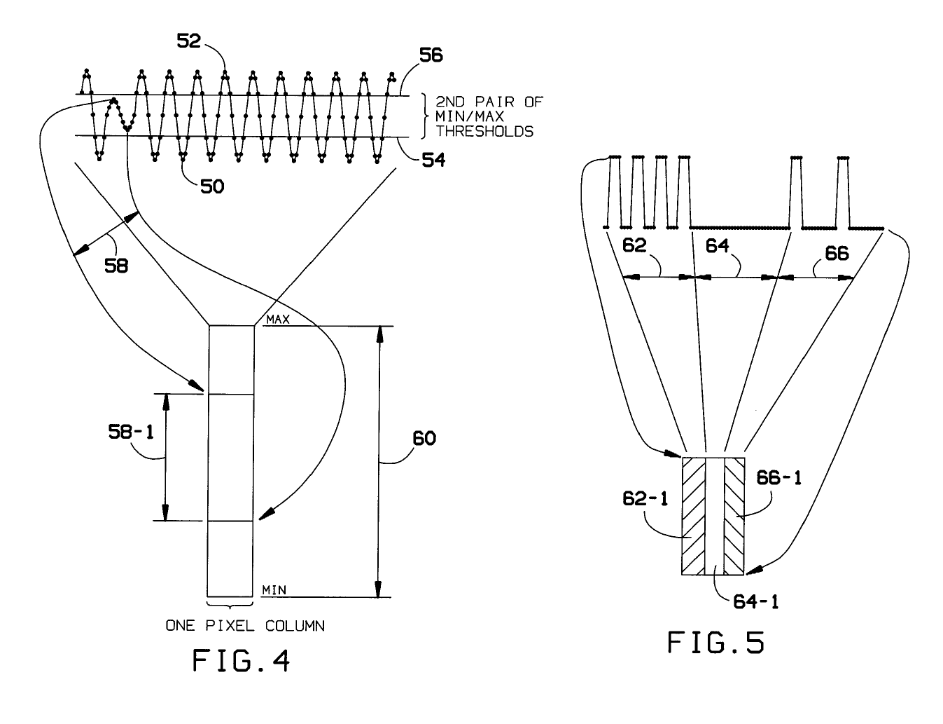

Referring now to FIG. 4, It may be noted that the above described two-point method can be extended to provide more detail of a waveform by highlighting possible data excursions that may be hidden between first Min/Max thresholds 50 and 52. By adding a second set of minimum and maximum thresholds 54 and 56 for a particular W, a smaller Min/Max pair of points 58 may be generated by excluding all points that are greater than the maximum threshold 56 and all points that are less than the minimum threshold 54. This second Min/Max pair 58 may be displayed by a vertical line 58-1 which may be superimposed on a line 60 that represents the Min/Max pair 50/52. The line 58-1 may be displayed in a different color or shade from the line 60, and may help identify acute excursions in the compressed waveform. Any number of new thresholds may be introduced to provide a higher level of detail of the waveform. Each additional threshold pair may introduce another pair of points that may be displayed.

Referring now to FIG. 5, it may be seen that using a different color to display or reveal more details about a waveform that has been compressed to one pixel column may also be applied to digitally captured data that may only have one Min/Max value. For example a logic analyzer will have values in the waveform that are either 1 or 0. For example, a first segment 62 of a waveform may be displayed in a pixel column 62-1. A second segment 64 may be displayed in pixel column 64-1 and so on. Different colors may be used in the pixel columns to highlight different densities of cycles or transitions within one pixel column. For every pixel column only one parameter needs to be transmitted to the display device and that is the number of transitions in a pixel column.

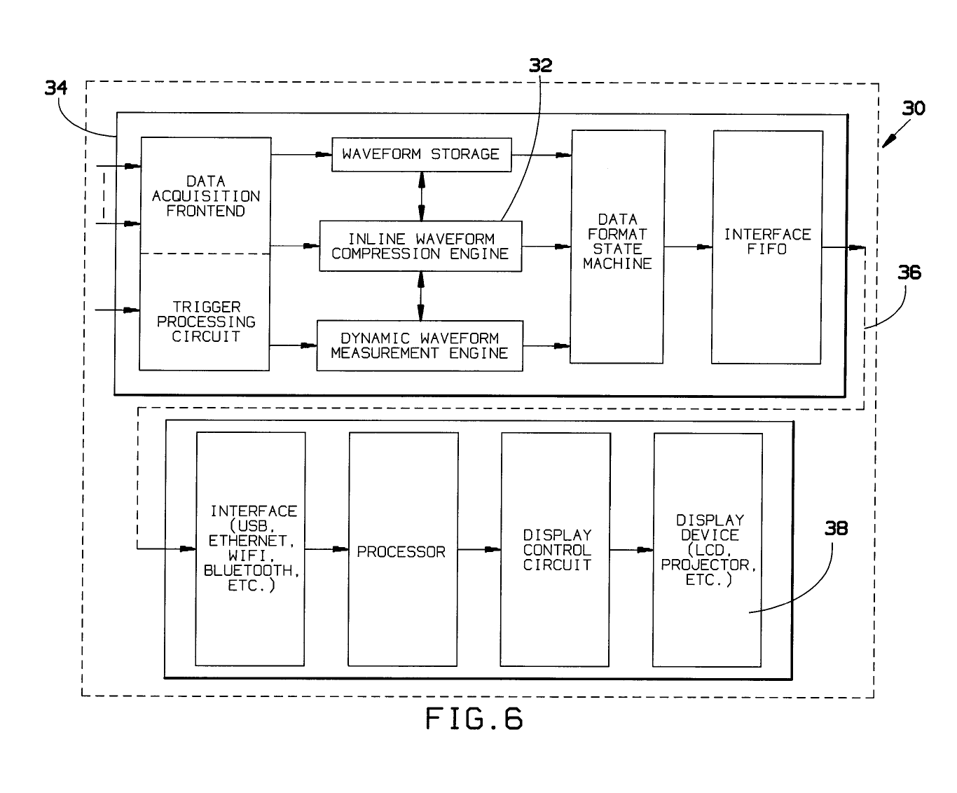

Referring now to FIG. 6, an exemplary embodiment of a system 30 may employ the above described two-point compression technique. This two-point method may be implemented on an integrated waveform compression engine 32 which may function in-line with an acquisition device 34. Simultaneously with data acquisition, an in-line waveform compression algorithm may be running in the waveform compression engine 32 to provide a real-time result. As soon as the capture is complete, the compressed waveform data memory may be ready to be read out through a system/peripheral bus in order to be displayed. The compression engine 32 may comprise an application specific integrated circuit (ASIC), a field programmable gate array (FPGA) or any other suitable programmable processing device. This may reduce the amount of data required to pass through a bus 36 to no more than two times the screen resolution of the display device 38, thus greatly reducing the amount of processing required to display the waveform.

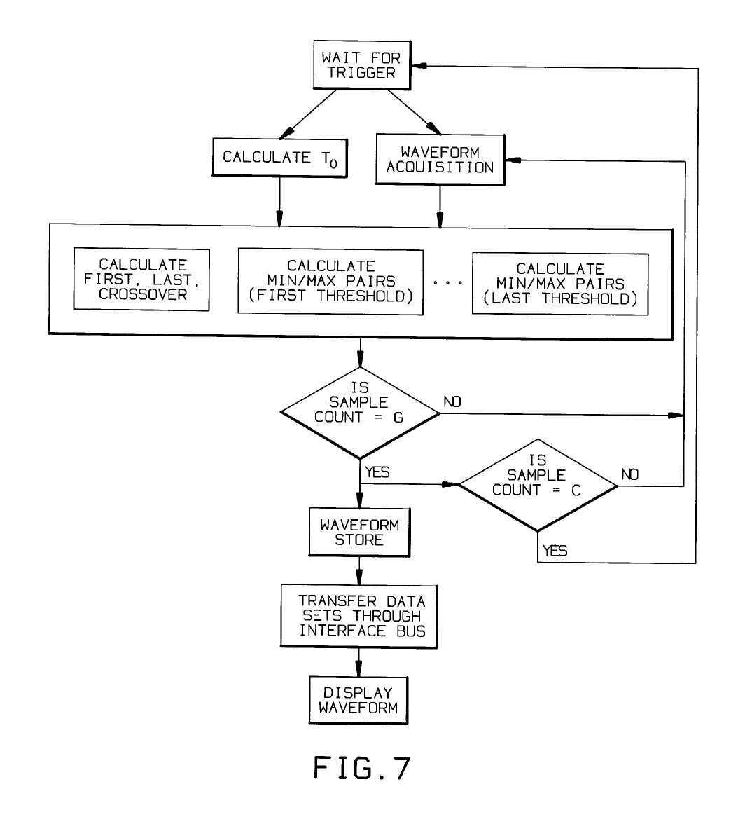

Referring now to FIG. 7, a flow chart shows an exemplary embodiment of a method for displaying waveform data in pixel format.

It should be understood, of course, that the foregoing relates to exemplary embodiments of the invention and that modifications may be made without departing from the spirit and scope of the invention as set forth in the following claims.

We claim:

1. Apparatus for analysis of waveform data comprising:
a data acquisition instrument for acquiring waveform data; and
a data compression engine for performing calculations in-line with the data acquisition to produce two-point sets from the data.

2. The apparatus of claim 1 further comprising:
an interface bus for transferring the two-point sets; and
a display device for displaying the two-point sets as representations of the waveform data as vertical lines of pixels.

3. The apparatus of claim 1 wherein the data compression engine performs calculations comprising:
calculating minimum/maximum pairs for adjacent vertical lines of pixels;
calculating last data points and first data points for the adjacent lines of pixels to define crossover points for the adjacent lines of pixels.

4. The apparatus of claim 1 wherein the data compression engine performs calculations comprising:
calculating a time (T₀) between a trigger event and a first sample time so that a crossover point is properly located on a y axis of a display.

5. The apparatus of claim 4 wherein the data compression engine performs calculations comprising generation of an interpolated time for the trigger event.

6. The apparatus of claim 5 wherein the data compression engine performs calculations comprising adding the time T₀ to a total capture time T_{c}.

7. The apparatus of claim 6 wherein the data compression engine performs calculations comprising determining a fractional time per pixel which can be used to calculate cross over points between pixel columns.

8. A method for displaying waveform data in pixels of a display comprising the steps of:
sampling a waveform to determine data points for each sampling time;
determining a time interval of a pixel on the display;
selecting a number of the sampled data points during a time interval associated with a pixel of the display;
assigning a first set of the selected number of the sampled data points to a first one of the time intervals;
assigning a second set of the selected number of sampled data points to a second one of the time intervals;
determining maximum and minimum excursions of the waveform data within the first selected time interval;
determining maximum and minimum excursions of the sampled data points within the second selected time interval;
determining magnitude of a last sampled data point within the first selected time interval;
determining magnitude of a first sampled data point within the second selected time interval;
calculating a crossover location on a y-axis as a function of a time interval associated with first pixel column;
establishing a display of a first vertical line of pixels wherein the first line includes the magnitude of the minimum and maximum excursion of the first selected time interval and both of the adjacent crossover locations; and
establishing a display of a second vertical line of pixels wherein the second line includes the magnitude of the minimum and maximum excursion of the second selected time interval and both of the adjacent crossover locations.

9. The method of claim 8 wherein the first and second vertical lines of pixels are adjacent to each other in the display.

10. The method of claim 8 wherein a sampling time interval is not required to equal an integer multiple of the time interval of a pixel of the display.

11. The method of claim 8 wherein the step of calculating a crossover comprises the steps of:
determining a trigger event;
generating an interpolated time for the trigger event;
calculating a time (T₀) between the interpolated time and a first sample;
adding T₀ to a total capture time T_{c};
calculating a fractional time T per pixel; and
accumulating the fractional time T per pixel for each consecutive pixel to calculate the crossover points.

12. A system for displaying waveform data comprising:
a data acquisition instrument for determining waveform data;
a waveform compression engine operating in-line with acquisition within the instrument;
a data transfer bus;
a display unit;
wherein the data transfer bus transfers compressed waveform data to the display unit.

13. The system of claim 12 wherein the waveform compression engine produces a two parameter data set to define a magnitude of adjacent vertical lines of pixel of the display unit.

14. The system of claim 13 wherein the parameter data set accounts for the crossover points between the adjacent vertical lines of pixels.

15. The system of claim 14 wherein the crossover point is determined by a last data point in first group of sampled data points and a first data point in a subsequent group of sample data points and the accumulated time interval Twi.
